(19) United States
(12) Patent Application Publication
(10) Pub. No.: US 2026/0280768 A1
(43) Pub. Date: Sep. 17, 2026

(54) THRESHOLD DETERMINATION FOR TRIGGERING MESSAGE REPETITIONS

(71) Applicant: Nokia Technologies Oy, Espoo (FI)

(72) Inventors: Leonardo CHIARELLO, Munich (DE); Marco MASO, Massy (FR); Alessio MARCONE, Munich (DE); Nhat-Quang NHAN, Massy (FR); Amir Mehdi AHMADIAN TEHRANI, Munich (DE)

(21) Appl. No.: 19/471,518

(22) PCT Filed: Mar. 14, 2024
(86) PCT No.: PCT/EP2024/056755

§ 371 Date: Oct. 1, 2025

(30) Foreign Application Priority Data
Apr. 6, 2023 (GB) 2305174.1

(51) Int. Cl. H04L 1/08; H04W 74/0833

(52) U.S. Cl. CPC H04L 1/08; H04W 74/0833

(57) ABSTRACT

There is provided an apparatus comprising means for means for receiving, at a user equipment, a threshold for triggering a request for repetitions of a third message of a random access procedure and means for determining at least one threshold for triggering repetitions of a first message of the random access procedure based on the received threshold.

### FIELD

The present application relates to a method, apparatus, system and computer program and in particular but not exclusively to determination of Synchronization Signal Block (SSB)-Received Signal Reference Power (RSRP) thresholds for Physical Random Access Channel (PRACH) repetitions and number of Msg3 Physical Uplink Shared Channel (PUSCH) repetitions.

### BACKGROUND

A communication system can be seen as a facility that enables communication sessions between two or more entities such as user terminals, base stations and/or other nodes by providing carriers between the various entities involved in the communications path. A communication system can be provided for example by means of a communication network and one or more compatible communication devices. The communication sessions may comprise, for example, communication of data for carrying communications such as voice, video, electronic mail (email), text message, multimedia and/or content data and so on. Non-limiting examples of services provided comprise two-way or multi-way calls, data communication or multimedia services and access to a data network system, such as the Internet.

In a wireless communication system at least a part of a communication session between at least two stations occurs over a wireless link. Examples of wireless systems comprise public land mobile networks (PLMN), satellite based communication systems and different wireless local networks, for example wireless local area networks (WLAN). Some wireless systems can be divided into cells, and are therefore often referred to as cellular systems.

A user can access the communication system by means of an appropriate communication device or terminal. A communication device of a user may be referred to as user equipment (UE) or user device. A communication device is provided with an appropriate signal receiving and transmitting apparatus for enabling communications, for example enabling access to a communication network or communications directly with other users. The communication device may access a carrier provided by a station, for example a base station of a cell, and transmit and/or receive communications on the carrier.

The communication system and associated devices typically operate in accordance with a given standard or specification which sets out what the various entities associated with the system are permitted to do and how that should be achieved. Communication protocols and/or parameters which shall be used for the connection are also typically defined. One example of a communications system is Universal Mobile Telecommunications System (UMTS) Terrestrial Radio Access Network (UTRAN) (3G radio). Other examples of communication systems are the long-term evolution (LTE) of the Universal Mobile Telecommunications System (UMTS) radio-access technology and so-called 5G or New Radio (NR) networks. NR is being standardized by the 3rd Generation Partnership Project (3GPP). Other examples of communication systems include 5G-Advanced (NR Rel-18 and beyond) and 6G.

### SUMMARY

In a first aspect there is provided an apparatus comprising means for receiving, at a user equipment, a threshold for triggering a request for repetitions of a third message of a random access procedure and means for determining at least one threshold for triggering repetitions of a first message of the random access procedure based on the received threshold.

The apparatus may comprise means for receiving at least one delta value from the network at the user equipment and means for determining the at least one threshold for triggering the repetitions of the first message of the random access procedure further based on the at least one delta value.

The at least one delta value may comprise a set of delta values and the at least one threshold may comprise a set of thresholds, each delta value of the set of delta values used by the apparatus to determine each threshold of the set of thresholds, each threshold of the set of thresholds corresponding to a number of repetitions of the first message of the random access procedure configured at the user equipment.

The received threshold and the at least one determined threshold may comprise a reference signal received power threshold of a synchronisation signal block.

The apparatus may comprise means for determining a number of repetitions of the third message of the random access procedure based on a number of repetitions of the first message of the random access procedure.

The number of repetitions of the third message of the random access procedure may be proportional to the number of repetitions of the first message.

The apparatus may comprise means for receiving an indication of multiple numbers of repetitions of the third message of the random access procedure from the network, wherein at least one of the multiple numbers of repetitions of the third message of the random access procedure is associated with at least one of multiple numbers of repetitions of the first message of the random access procedure configured at the user equipment and means for determining the number of repetitions of the third message of the random access procedure based on the indication.

The apparatus may comprise means for receiving configuration related to the determined at least one threshold, the configuration associating a number of repetitions of the first message of the random access procedure to the at least one determined threshold and either a number of repetitions of the third message of the random access procedure or a proportionality factor to be applied to the associated number of repetitions of the first message to determine the number of repetitions of the third message of the random access procedure to the at least one determined threshold.

The apparatus may comprise means for receiving an uplink grant or downlink control information from the network and means for determining whether to perform repetitions of the third message of the random access procedure based on the uplink grant or downlink control information.

The uplink grant or downlink control information may comprise a modulation and coding scheme and the apparatus may comprise means for determining whether to perform repetitions of the third message of the random access procedure based on one most significant bit of the modulation and coding scheme.

The apparatus may comprise means for determining the number of repetitions of the third message of the random access procedure based on at least one of the remaining bits of the modulation and coding scheme.

In a second aspect there is provided a method comprising receiving, at a user equipment, a threshold for triggering a request for repetitions of a third message of a random access procedure and determining at least one threshold for triggering repetitions of a first message of the random access procedure based on the received threshold.

The method may comprise receiving at least one delta value from the network at the user equipment and determining the at least one threshold for triggering the repetitions of the first message of the random access procedure further based on the at least one delta value.

The at least one delta value may comprise a set of delta values and the at least one threshold may comprise a set of thresholds, each delta value of the set of delta values used by the apparatus to determine each threshold of the set of thresholds, each threshold of the set of thresholds corresponding to a number of repetitions of the first message of the random access procedure configured at the user equipment.

The received threshold and the at least one determined threshold may comprise a reference signal received power threshold of a synchronisation signal block.

The method may comprise determining a number of repetitions of the third message of the random access procedure based on a number of repetitions of the first message of the random access procedure.

The number of repetitions of the third message of the random access procedure may be proportional to the number of repetitions of the first message.

The method may comprise receiving an indication of multiple numbers of repetitions of the third message of the random access procedure from the network, wherein at least one of the multiple numbers of repetitions of the third message of the random access procedure is associated with at least one of multiple numbers of repetitions of the first message of the random access procedure configured at the user equipment and determining the number of repetitions of the third message of the random access procedure based on the indication.

The method may comprise receiving a configuration related to the determined at least one threshold, the configuration associating a number of repetitions of the first message of the random access procedure to the at least one determined threshold and either a number of repetitions of the third message of the random access procedure or a proportionality factor to be applied to the associated number of repetitions of the first message to determine the number of repetitions of the third message of the random access procedure to the at least one determined threshold.

The method may comprise receiving an uplink grant or downlink control information from the network and determining whether to perform repetitions of the third message of the random access procedure based on the uplink grant or downlink control information.

The uplink grant or downlink control information may comprise a modulation and coding scheme and the method may comprise determining whether to perform repetitions of the third message of the random access procedure based on one most significant bit of the modulation and coding scheme.

The method may comprise determining the number of repetitions of the third message of the random access procedure based on at least one of the remaining bits of the modulation and coding scheme.

In a third aspect there is provided an apparatus comprising at least one processor and at least one memory storing instructions that, when executed by the at least one processor, cause the apparatus at least to receive, at a user equipment, a threshold for triggering a request for repetitions of a third message of a random access procedure and determine at least one threshold for triggering repetitions of a first message of the random access procedure based on the received threshold.

The apparatus may be caused to receive at least one delta value from the network at the user equipment and determine the at least one threshold for triggering the repetitions of the first message of the random access procedure further based on the at least one delta value.

The at least one delta value may comprise a set of delta values and the at least one threshold comprises a set of thresholds, each delta value of the set of delta values used by the apparatus to determine each threshold of the set of thresholds, each threshold of the set of thresholds corresponding to a number of repetitions of the first message of the random access procedure configured at the user equipment.

The received threshold and the at least one determined threshold may comprise a reference signal received power threshold of a synchronisation signal block.

The apparatus may be caused to determine a number of repetitions of the third message of the random access procedure based on a number of repetitions of the first message of the random access procedure.

The number of repetitions of the third message of the random access procedure may be proportional to the number of repetitions of the first message.

The apparatus may be caused to receive an indication of multiple numbers of repetitions of the third message of the random access procedure from the network, wherein at least one of the multiple numbers of repetitions of the third message of the random access procedure is associated with at least one of multiple numbers of repetitions of the first message of the random access procedure configured at the user equipment and determine the number of repetitions of the third message of the random access procedure based on the indication.

The apparatus may be caused to receive a used by the apparatus to determine each threshold of the set of thresholds, each threshold of the set of threshold associating a number of repetitions of the first message of the random access procedure to the at least one determined threshold and either a number of repetitions of the third message of the random access procedure or a proportionality factor to be applied to the associated number of repetitions of the first message to determine the number of repetitions of the third message of the random access procedure to the at least one determined threshold.

The apparatus may be caused to receive an uplink grant or downlink control information from the network and determine whether to perform repetitions of the third message of the random access procedure based on the uplink grant or downlink control information.

The uplink grant or downlink control information may comprise a modulation and coding scheme and the apparatus may be caused to determine whether to perform repetitions of the third message of the random access procedure based on one most significant bit of the modulation and coding scheme.

The apparatus may be caused to determine the number of repetitions of the third message of the random access procedure based on at least one of the remaining bits of the modulation and coding scheme.

In a fourth aspect there is provided a computer readable medium comprising instructions which, when executed by an apparatus, cause the apparatus to perform at least the following receiving, at a user equipment, a threshold for triggering a request for repetitions of a third message of a random access procedure and determining at least one threshold for triggering repetitions of a first message of the random access procedure based on the received threshold.

The apparatus may be caused to perform receiving at least one delta value from the network at the user equipment and determining the at least one threshold for triggering the repetitions of the first message of the random access procedure further based on the at least one delta value.

The at least one delta value may comprise a set of delta values and the at least one threshold comprises a set of thresholds, each delta value of the set of delta values used by the apparatus to determine each threshold of the set of thresholds, each threshold of the set of thresholds corresponding to a number of repetitions of the first message of the random access procedure configured at the user equipment.

The received threshold and the at least one determined threshold may comprise a reference signal received power threshold of a synchronisation signal block.

The apparatus may be caused to perform determining a number of repetitions of the third message of the random access procedure based on a number of repetitions of the first message of the random access procedure.

The number of repetitions of the third message of the random access procedure may be proportional to the number of repetitions of the first message.

The apparatus may be caused to perform receiving an indication of multiple numbers of repetitions of the third message of the random access procedure from the network, wherein at least one of the multiple numbers of repetitions of the third message of the random access procedure is associated with at least one of multiple numbers of repetitions of the first message of the random access procedure configured at the user equipment and determining the number of repetitions of the third message of the random access procedure based on the indication.

The apparatus may be caused to perform receiving a configuration related to the determined at least one threshold, the configuration associating a number of repetitions of the first message of the random access procedure to the determined at least one threshold and either a number of repetitions of the third message of the random access procedure or a proportionality factor to be applied to the associated number of repetitions of the first message to determine the number of repetitions of the third message of the random access procedure to the determined at least one threshold.

The apparatus may be caused to perform receiving an uplink grant or downlink control information from the network and determining whether to perform repetitions of the third message of the random access procedure based on the uplink grant or downlink control information.

The uplink grant or downlink control information may comprise a modulation and coding scheme and the apparatus may be caused to perform determining whether to perform repetitions of the third message of the random access procedure based on one most significant bit of the modulation and coding scheme.

The apparatus may be caused to perform determining the number of repetitions of the third message of the random access procedure based on at least one of the remaining bits of the modulation and coding scheme.

In a fifth aspect there is provided a non-transitory computer readable medium comprising program instructions for causing an apparatus to perform at least the method according to the third or fourth aspect.

In the above, many different embodiments have been described. It should be appreciated that further embodiments may be provided by the combination of any two or more of the embodiments described above.

### DESCRIPTION OF FIGURES

Embodiments will now be described, by way of example only, with reference to the accompanying Figures in which: FIG. 1 shows a schematic diagram of an example 5GS communication system;

FIG. 2 shows a schematic diagram of an example mobile communication device;

FIG. 3 shows a schematic diagram of an example control apparatus;

FIG. 4 shows a signalling diagram between a UE and a gNB for a 4-step Random Access Channel (RACH) procedure;

FIG. 5 shows a signalling diagram between a UE and a gNB for a 4-step RACH procedure involving Msg1 and Msg3 repetitions;

FIG. 6 shows a flowchart of a method according to an example embodiment

FIG. 7 shows a signalling diagram according to an example embodiment;

FIG. 8 shows a signalling diagram according to an example embodiment.

### DETAILED DESCRIPTION

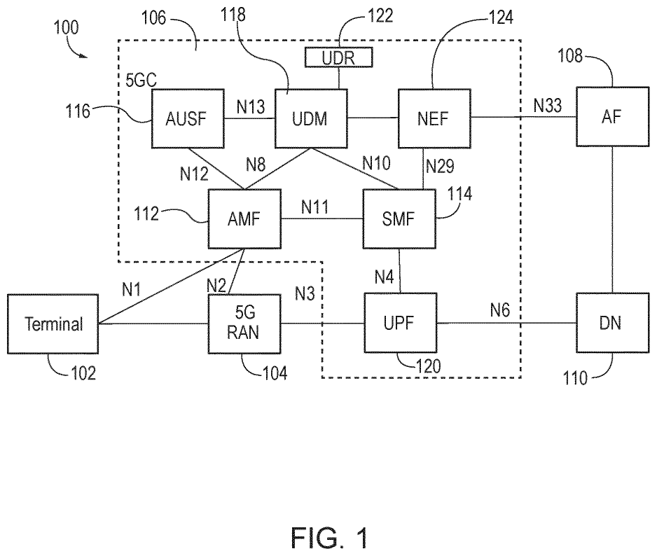

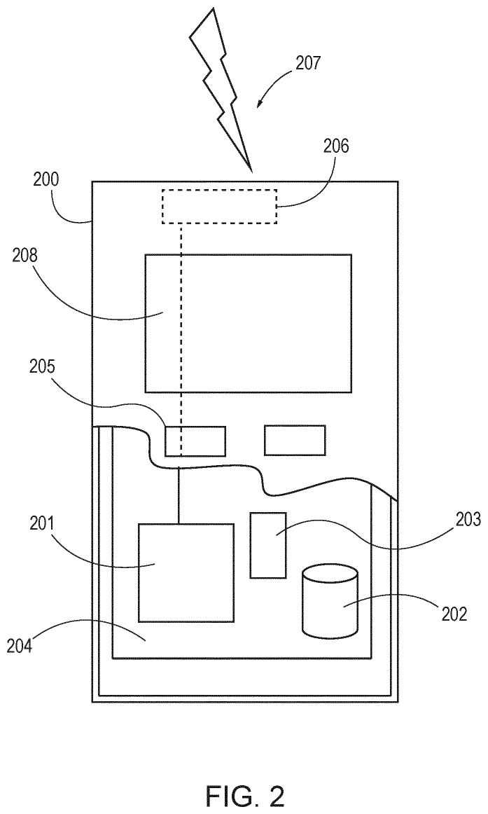

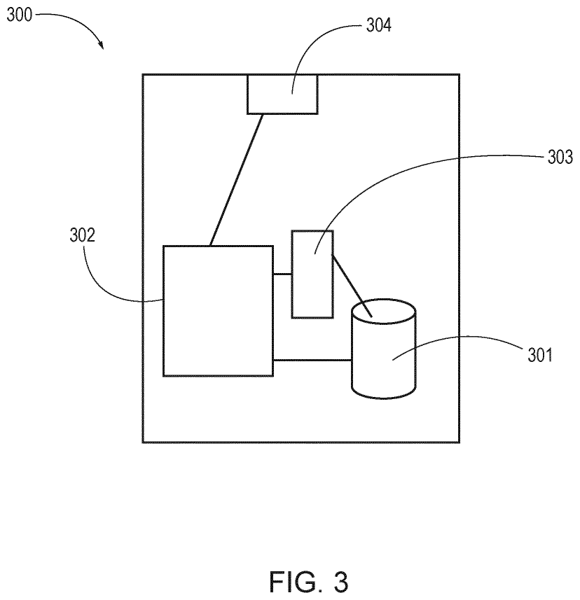

Before explaining in detail the examples, certain general principles of a wireless communication system and mobile communication devices are briefly explained with reference to FIG. 1, FIG. 2 and FIG. 3 to assist in understanding the technology underlying the described examples.

An example of a suitable communications system is the 5G or NR concept. Network architecture in NR may be similar to that of LTE-advanced. Base stations of NR systems may be known as next generation NodeBs (gNBs). Changes to the network architecture may depend on the need to support various radio technologies and finer Quality of Service (QOS) support, and some on-demand requirements for e.g. QoS levels to support Quality of Experience (QoE) for a user. Also network aware services and applications, and service and application aware networks may bring changes to the architecture. Those are related to Information Centric Network (ICN) and User-Centric Content Delivery Network (UC-CDN) approaches. NR may use Multiple Input-Multiple Output (MIMO) antennas, many more base stations or nodes than the LTE (a so-called small cell concept), including macro sites operating in co-operation with smaller stations and perhaps also employing a variety of radio technologies for better coverage and enhanced data rates.

Future networks may utilise network functions virtualization (NFV) which is a network architecture concept that proposes virtualizing network node functions into “building blocks” or entities that may be operationally connected or linked together to provide services. A virtualized network function (VNF) may comprise one or more virtual machines running computer program codes using standard or general type servers instead of customized hardware. Cloud computing or data storage may also be utilized. In radio communications this may mean node operations to be carried out, at least partly, in a server, host or node operationally coupled to a remote radio head. It is also possible that node operations will be distributed among a plurality of servers, nodes or hosts. It should also be understood that the distribution of labour between core network operations and base station operations may differ from that of the LTE or even be non-existent.

FIG. 1 shows a schematic representation of a 5G system (5GS) 100. The 5GS may comprise a user equipment (UE) 102 (which may also be referred to as a communication device or a terminal), a 5G radio access network (5GRAN) 104, a 5G core network (5GCN) 106, one or more internal or external application functions (AF) 108 and one or more data networks (DN) 110.

An example 5G core network (CN) comprises functional entities. The 5GCN 106 may comprise one or more Access and mobility Management Functions (AMF) 112, one or more session management functions (SMF) 114, an authentication server function (AUSF) 116, a Unified Data Management (UDM) 118, one or more user plane functions (UPF) 120, a Unified Data Repository (UDR) 122 and/or a Network Exposure Function (NEF) 124. The UPF is controlled by the SMF (Session Management Function) that receives policies from a PCF (Policy Control Function).

The CN is connected to a UE via the Radio Access Network (RAN). The 5GRAN may comprise one or more gNodeB (gNB) Distributed Unit (DU) functions connected to one or more gNodeB (gNB) Centralized Unit (CU) functions. The RAN may comprise one or more access nodes.

A User Plane Function (UPF) referred to as PDU Session Anchor (PSA) may be responsible for forwarding frames back and forth between the DN and the tunnels established over the 5G towards the UE(s) exchanging traffic with the DN.

A possible mobile communication device will now be described in more detail with reference to FIG. 2 showing a schematic, partially sectioned view of a communication device 200. Such a communication device is often referred to as user equipment (UE) or terminal. An appropriate mobile communication device may be provided by any device capable of sending and receiving radio signals. Non-limiting examples comprise a mobile station (MS) or mobile device such as a mobile phone or what is known as a ‘smart phone’, a computer provided with a wireless interface card or other wireless interface facility (e.g., USB dongle), personal data assistant (PDA) or a tablet provided with wireless communication capabilities, voice over IP (VoIP) phones, portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), smart devices, wireless customer-premises equipment (CPE), or any combinations of these or the like. A mobile communication device may provide, for example, communication of data for carrying communications such as voice, electronic mail (email), text message, multimedia and so on. Users may thus be offered and provided numerous services via their communication devices. Non-limiting examples of these services comprise two-way or multi-way calls, data communication or multimedia services or simply an access to a data communications network system, such as the Internet. Users may also be provided broadcast or multicast data. Non-limiting examples of the content comprise downloads, television and radio programs, videos, advertisements, various alerts, and other information.

A mobile device is typically provided with at least one data processing entity 201, at least one memory 202 and other possible components 203 for use in software and hardware aided execution of tasks it is designed to perform, including control of access to and communications with access systems and other communication devices. The data processing, storage and other relevant control apparatus can be provided on an appropriate circuit board and/or in chipsets. This feature is denoted by reference 204. The user may control the operation of the mobile device by means of a suitable user interface such as key pad 205, voice commands, touch sensitive screen or pad, combinations thereof or the like. A display 208, a speaker and a microphone can be also provided. Furthermore, a mobile communication device may comprise appropriate connectors (either wired or wireless) to other devices and/or for connecting external accessories, for example hands-free equipment, thereto.

The mobile device 200 may receive signals over an air or radio interface 207 via appropriate apparatus for receiving and may transmit signals via appropriate apparatus for transmitting radio signals. In FIG. 2 transceiver apparatus is designated schematically by block 206. The transceiver apparatus 206 may be provided for example by means of a radio part and associated antenna arrangement. The antenna arrangement may be arranged internally or externally to the mobile device.

FIG. 3 shows an example of a control apparatus 300 for a communication system, for example to be coupled to and/or for controlling a station of an access system, such as a RAN node, e.g. a base station, eNB or gNB, a relay node or a core network node such as an MME or

Serving Gateway (S-GW) or Packet Data Network Gateway (P-GW), or a core network function such as AMF/SMF, or a server or host. The method may be implemented in a single control apparatus or across more than one control apparatus. The control apparatus may be integrated with or external to a node or module of a core network or RAN. In some embodiments, base stations comprise a separate control apparatus unit or module. In other embodiments, the control apparatus can be another network element such as a radio network controller or a spectrum controller. In some embodiments, each base station may have such a control apparatus as well as a control apparatus being provided in a radio network controller. The control apparatus 300 can be arranged to provide control on communications in the service area of the system. The control apparatus 300 comprises at least one memory 301, at least one data processing unit 302, 303 and an input/output interface 304. Via the interface the control apparatus can be coupled to a receiver and a transmitter of the base station. The receiver and/or the transmitter may be implemented as a radio front end or a remote radio head.

As described in 3GPP standards, in 5G NR, two contention based random access (CBRA) procedures are supported, namely 4-step RACH (Rel-15) and 2-step RACH (Rel-16).

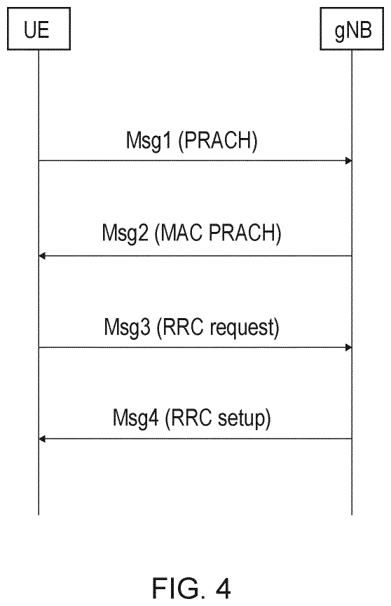

As shown in FIG. 4, the 4-step RACH procedure can be summarized in the following messages.
1. Msg1 (a.k.a. PRACH): The UE sends a specific preamble to the gNB via physical random-access channel (PRACH) using a specific resource called RACH occasion (RO).
2. Msg2 (a.k.a. RAR): The gNB replies with a random-access response (RAR) message, which includes the detected preamble ID, the time-advance command, a Temporary Cell-Radio Network Temporary Identifier (TC-RNTI), and uplink (UL) grant for the transmission of Msg3 on PUSCH.
3. Msg3 (a.k.a. Radio Resource Control (RRC) request): The UE responds to Msg2 over the scheduled PUSCH with an ID for contention resolution.
4. Msg4 (a.k.a. RRC setup): The gNB transmits the contention resolution message with the contention-resolution ID.

Upon reception of Msg4, the UE sends an ACK on a PUCCH if its contention-resolution ID is carried by Msg4. This completes the 4-step RACH. Prior to Msg1, there is also a preliminary step of sending and receiving the synchronization signal block (SSB), i.e., downlink (DL) beam sweeping, which is not formally part of the RACH procedure. As a result of this preliminary step, the UE selects the index of the preferred SSB beam and decodes the associated Physical Broadcast Channel (PBCH) for Master Information Block (MIB), System information

Block (SIB) and so on. This index is also used by UE to identify a suitable RO for the preamble transmission (Msg1), according to the SSB-to-RO mapping implicitly conveyed by SIB1.

As described in 3GPP standards, a UE can be provided, via the field numberOfMsg3-RepetitionsList in the higher layer Information Element (IE) BWP-UplinkCommon, a set of numbers of repetitions for a PUSCH transmission with PUSCH repetition Type A that is scheduled by a RAR UL grant (such as the example RAR UL grant shown in Table 1) or by a downlink control information (DCI) format 0_0 with cyclic redundancy check (CRC) scrambled by a TC-RNTI.

TABLE 1

| RAR grant field | Number of bits |
|---|---|
| Frequency hopping flag | 1 |
| PUSCH frequency resource | 12, for operation with shared spectrum |
| allocation | channel access in FR1 or for FR2-2 when |
| | ChannelAccessMode2-r17 is provided |
| | 14, otherwise |
| PUSCH time resource | 4 |
| allocation | |
| MCS | 4 |
| TPC command for PUSCH | 3 |
| CSI request | 1 |
| ChannelAccess-CPext | 2, for operation with shared spectrum |
| | channel access in FR1 or for FR2-2 when |
| | ChannelAccessMode2-r17 is provided |
| | 0, otherwise |

If the UE requests repetitions for the Msg3 PUSCH transmission via PRACH resource selection, the UE transmits the PUSCH over

$${N}_{PUSCH}^{repeat}$$

slots, where

$${N}_{PUSCH}^{repeat}$$

is indicated by the 2 MSBs of the MCS field in the RAR UL grant or in the DCI format 0_0 from a set of four values provided by numberOfMsg3-RepetitionsList or from {1, 2, 3, 4} if numberOfMsg3-RepetitionsList is not provided (see Table 2).

TABLE 2

| numberOfMsg3- | | numberOfMsg3- | |
|---|---|---|---|
| RepetitionsList is configured | | RepetitionsList is not configured | |
| Codepoint | K | Codepoint | K |
| 00 | First value of | 00 | 1 |
| | numberOfMsg3- | | |
| | RepetitionsList | | |
| 01 | Second value of | 01 | 2 |
| | numberOfMsg3- | | |
| | RepetitionsList | | |
| 10 | Third value of | 10 | 3 |
| | numberOfMsg3- | | |
| | RepetitionsList | | |
| 11 | Fourth value of | 11 | 4 |
| | numberOfMsg3- | | |
| | RepetitionsList | | |

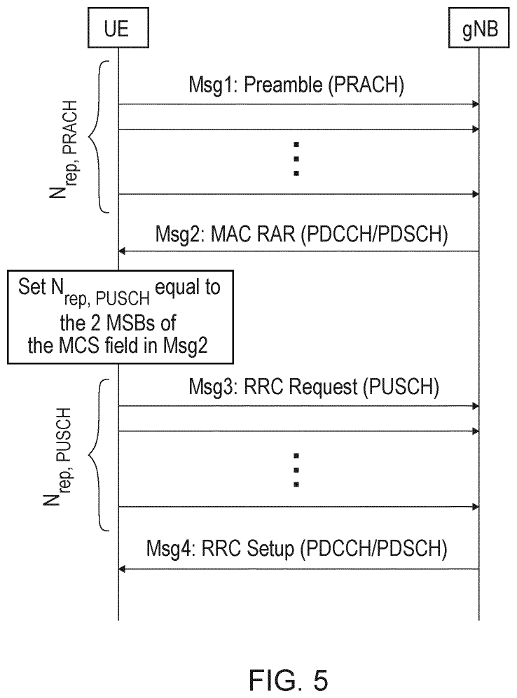

FIG. 5 shows a legacy procedure for deriving the number of Msg3 repetitions. The UE transmits the Msg1 (PRACH) with N_{rep,PRACH} repetitions. The gNB provides Msg2 (MAC RAR) and the UE sets N_{rep,PUSCH} equal to the 2 MSBs of the MCS field in Msg2. The UE transmits Msg3 (RRC Request) with N_{rep,PUSCH} repetitions and receives Msg4 (RRC setup) from the gNB.

According to simulation results, the coverage performance of PRACH is better than that of Msg3 PUSCH. In other words, if coverage of PRACH is an issue, coverage of Msg3 PUSCH would be an issue as well. Therefore, from a coverage perspective, if PRACH repetitions are used for PRACH coverage improvement, Msg3 PUSCH repetitions should also be enabled. This may simplify the interaction between PRACH repetitions and Msg3 PUSCH repetitions, since there is no need to distinguish between the two cases of Msg3 PUSCH with repetitions and Msg3 PUSCH without repetition if PRACH repetitions are triggered, which avoids further PRACH partitioning. In addition, if the Msg3 PUSCH repetitions are always enabled if PRACH repetitions are triggered, four candidate numbers of Msg3 repetitions including the value ‘1’ representing no Msg3 PUSCH repetition can be dynamically indicated by gNB. Hence, it is still up to gNB to decide whether to perform Msg3 PUSCH repetitions.

Because both Msg3 repetition request and PRACH repetition are expected to be for Ues with similar condition (i.e. needing coverage enhancement for UL RACH messages), usage of PRACH repetition by UE may be considered as an indication of Msg3 repetition request too. This approach may make PRACH resource usage more efficient (by avoiding excessive partitioning).

One proposal is to support the combination of PRACH resources (and/or RACH occasions) and PRACH repetition to indicate the Msg3 repetition request by UE. For example, the option that PRACH repetition can automatically indicate Msg3 repetition request (irrespective of PRACH resource) may be supported.

Methods for enabling the interaction between PRACH repetitions and Msg3 repetitions are considered in the following.

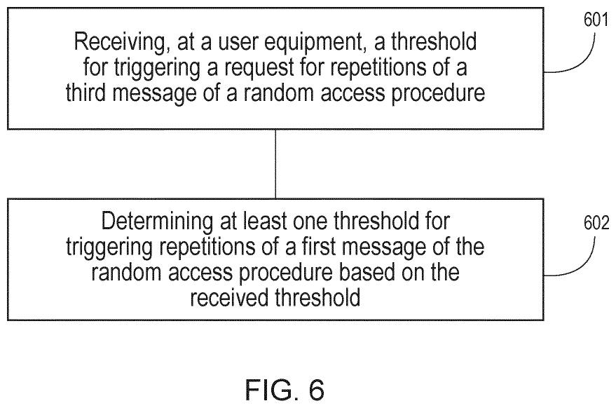

FIG. 6 shows a flowchart of a method according to an example embodiment. The method may be performed at a UE.

In 601 the method comprises receiving, at a user equipment, a threshold for triggering a request for repetitions of a third message of a random access procedure.

In 602, the method comprises determining at least one threshold for triggering repetitions of a first message of the random access procedure based on the received threshold.

The first message may be referred to as Message1 or Msg1 of a RA procedure. The third message may be referred to as Message3 or Msg3 of a RA procedure.

The method may comprise receiving at least one delta value from the network at the user equipment and means for determining the at least one threshold for triggering the repetitions of the first message of the random access procedure further based on the at least one delta value.

The at least one delta value may comprise a set of delta values used by the apparatus to determine each threshold of the set of thresholds, each delta value of the set of delta values used by the apparatus to determine each threshold of the set of thresholds corresponding to a number of repetitions of the first message of the random access procedure configured at the user equipment.

The received threshold and the at least one determined threshold may comprise a reference signal received power threshold of a synchronisation signal block (also referred to as a SSB-RSRP threshold). The received threshold may be the configured value rsrp-ThresholdMsg3-r17. The SSB-RSRP threshold value for PRACH repetitions is an example of the at least one determined threshold.

In an example embodiment, a UE determines the SSB-RSRP threshold(s) for triggering of PRACH repetitions based on the configured rsrp-ThresholdMsg3-r17. Each threshold of the determined threshold(s) represents a higher threshold (in power domain) of an range (e.g., a SSB-RSRP range or also referred to as coverage enhancement level in this application) within which a certain configured number of repetitions of the first message of the random access procedure applies. In other words, if the UE measures an SSB-RSRP within an SSB-RSRP range, the UE transmits a number of PRACH repetitions determined based on a configuration for the SSB-RSRP range.

In one example embodiment, a field, including the at least one delta value, is introduced in BWP-UplinkCommon and the value(s) of the SSB-RSRP threshold(s) for PRACH repetitions are derived from such field.

That is, the method for Msg1 PRACH repetitions determination comprises the introduction of a field in BWP-UplinkCommon to derive the SSB-RSRP threshold(s) for PRACH repetitions from such field. As an example, consider the introduction of a field called rsrp-ThresholdOffsetList containing a value (or a set of values) expressed in dB. Moreover, let's consider rsrp-ThresholdMsg3-r17=10 dB. Using these assumptions, we can provide further examples for the different embodiments.

In a first example embodiment, the SSB-RSRP threshold(s) for PRACH repetitions are derived from rsrp-ThresholdOffsetList.

For example, if one number of PRACH repetitions is configured, the field may contain one delta value and the corresponding SSB-RSRP threshold value for PRACH repetitions is derived as a scaled/offsetted version of the value rsrp-ThresholdMsg3-r17 (e.g. by summing up, or subtracting, the delta value to the value of the Msg3 threshold).

In this example embodiment, one number of PRACH repetitions is configured (e.g., N_{rep,PRACH}=4). For this embodiment, let's define the rsrp-ThresholdOffsetList as a 1-element set containing a value indicating the offset of the SSB-RSRP threshold from rsrp-ThresholdMsg3-r17, e.g., rsrp-ThresholdOffsetList={-3} dB. The corresponding SSB-RSRP threshold value is derived from rsrp-ThresholdMsg3-r17 as rsrp-ThresholdMsg1List=rsrp-ThresholdMsg3-r17+rsrp-ThresholdOffsetList=10 dB+(−3) dB=7 dB.

If multiple numbers of PRACH repetitions are configured, the new field may contain multiple delta values and the corresponding SSB-RSRP threshold values for PRACH repetitions are derived as scaled/offsetted versions of the value rsrp-ThresholdMsg3-r17 (e.g. by summing up, or subtract, the delta values of the new field to the value of the Msg3 threshold).

In this example embodiment, a multiple number of PRACH repetitions is configured (4 in this example, e.g., [symbol] _{rep,PRACH} E {2, 4, 6, 8} with size |N_{rep,PRACH}|=4). For this embodiment, let's define rsrp-ThresholdOffsetList as a set of values (of size equal to size of the set of the number of PRACH repetitions |N_{rep,PRACH}|) indicating the offsets of the SSB-RSRP thresholds to rsrp-ThresholdMsg3-r17. For this example let's assume rsrp-ThresholdOffsetList={−3, −5, −6, −9} dB. Therefore, the SSB-RSRP threshold values can be derived from rsrp-ThresholdMsg3-r17 as rsrp-ThresholdMsg1List=rsrp-ThresholdMsg3-r17+rsrp-ThresholdOffsetList=10 dB+{−3, −5, −6, −9} dB={7, 5, 4, 1} dB.

If multiple numbers of PRACH repetitions are configured, the new field may contain multiple delta values and the highest SSB-RSRP threshold value for PRACH repetitions may be derived from one value of the delta values as scaled/offsetted versions of the value rsrp-ThresholdMsg3-r17 (e.g. by summing up, or subtracting, the highest among the delta values carried by the new field to the value of the Msg3 threshold), while all other SSB-RSRP thresholds are derived as scaled version of the highest SSB-RSRP threshold from the other remaining values of the delta values.

In this example embodiment, case a multiple number of PRACH repetitions is configured (4 in this example, e.g., N_{rep,PRACH} ⊂ {2, 4, 6, 8} with size |N_{rep,PRACH}|=4). For this embodiment, let's define rsrp-ThresholdOffsetList as a set of values (of size equal to size of the set of the number of PRACH repetitions |N_{rep,PRACH}) where the first value (but it could be another value of the set) indicates the offset of the largest SSB-RSRP threshold to rsrp-ThresholdMsg3-r17, while the other values indicate the offset of the other SSB-RSRP thresholds to rsrp-LargestThresholdMsg1. For this example let's assume rsrp-ThresholdOffsetList={−3, −2, −3, −6} dB. Therefore, the largest SSB-RSRP threshold value can be derived from rsrp-ThresholdMsg3-r17 as rsrp-ThresholdMsg1List (1)=rsrp-ThresholdMsg3-r17+rsrp-ThresholdOffsetList (1)=10 dB-3 dB=7 dB, while the other SSB-RSRP threshold values can be derived as rsrp-ThresholdMsg1List (2,3,4)=rsrp-ThresholdMsg1List (1)+rsrp-ThresholdOffsetList (2,3,4)=7 dB+{−2, −3, −6} dB={5, 4, 1} dB, leading to the following complete set: rsrp-ThresholdMsg1List={7, 5, 4, 1} dB.

If multiple numbers of PRACH repetitions are configured, the new field may contain multiple delta values and the highest SSB-RSRP threshold value for PRACH repetitions is derived from one value of the delta values as scaled/offsetted versions of the value rsrp-ThresholdMsg3-r17 (e.g. by summing up, or subtract, the highest among the delta values carried by the new field to the value of the Msg3 threshold), while all other SSB-RSRP thresholds are derived recursively as scaled version of the previously determined SSB-RSRP threshold from the other remaining values of the delta values, e.g. the (i+1)-th threshold is derived from the i-th threshold plus/minus the applicable delta value.

In this example embodiment, where a multiple number of PRACH repetitions is configured (4 in this example, e.g., [symbol] _{rep,PRACH} E {2, 4, 6, 8} with size | [symbol] _{rep,PRACH}|=4) and defining rsrp-ThresholdOffsetList as a set of values (of size equal to size of the set of the number of PRACH repetitions | [symbol] _{rep,PRACH}|) where the first value (but it could be another value of the set) indicates the offset of the largest SSB-RSRP threshold to rsrp-ThresholdMsg3-r17, while the other values indicate the offset of each SSB-RSRP threshold to the previously determined SSB-RSRP threshold. For this example let's assume rsrp-ThresholdOffsetList={−3, −2, −1, −3} dB. Therefore, the largest SSB-RSRP threshold value can be derived from rsrp-ThresholdMsg3-r17 as rsrp-ThresholdMsg1List (1)=rsrp-ThresholdMsg3-r17+rsrp-ThresholdOffsetList (1)=10 dB-3 dB=7 dB, while the other SSB-RSRP threshold values can be derived as rsrp-ThresholdMsg1List (2)=rsrp-ThresholdMsg1List (1)+rsrp-ThresholdOffsetList (2)=7 dB +−2 dB=5 dB, rsrp-ThresholdMsg1List (3)=rsrp-ThresholdMsg 1List (2)+rsrp-ThresholdOffsetList (3)=5 dB+−1 dB=4 dB, rsrp-ThresholdMsg1List (4)=rsrp-ThresholdMsg1List (3)+rsrp-ThresholdOffsetList (4)=4 dB+−3 dB=1 dB, leading to the following complete set: rsrp-ThresholdMsg 1List={7, 5, 4, 1} dB.

In another embodiment, if the at least one delta value is not configured, the largest SSB-RSRP threshold is set equal to the value of rsrp-ThresholdMsg3-r17.

If one number of PRACH repetitions is configured, the value of the SSB-RSRP threshold is equal to the largest SSB-RSRP threshold value.

If multiple number of PRACH repetitions are configured, the other SSB-RSRP thresholds are derived as a scaled/offsetted versions of the largest SSB-RSRP threshold based on scaling factors further configured from gNB in addition to the new field.

Alternatively, if multiple number of PRACH repetitions are configured, the other SSB-RSRP thresholds are derived as a scaled/offsetted versions of the closest SSB-RSRP threshold based on scaling factors further configured from gNB in addition to the new field.

In an example embodiment, the field rsrp-ThresholdOffsetList is introduced but not configured. This is an example of determining a threshold for triggering a given number of repetitions of a first message of the random access procedure based on the received threshold. In this case the largest SSB-RSRP threshold may be set equal to the value of rsrp-ThresholdMsg3-r17, i.e., rsrp-LargestThresholdMsg1=rsrp-ThresholdMsg3-r17=10 dB.

As an example embodiment, where one number of PRACH repetitions is configured, the value of the SSB-RSRP threshold is equal to the largest SSB-RSRP threshold value, i.e., rsrp-ThresholdMsg 1List=rsrp-LargestThresholdMsg1=10 dB;

As an example embodiment, where a multiple number of PRACH repetitions is configured, the corresponding SSB-RSRP threshold values could be derived as rsrp-ThresholdMsg 1List (1)=rsrp-LargestThresholdMsg1, rsrp-ThresholdMsg1List (2,3,4)=rsrp-LargestThresholdMsg1+rsrp-ThresholdOffsetList=10 dB+{−2, −3, −6} dB={8, 7, 4} dB, where rsrp-ThresholdOffsetList={−2, −3, −6} dB contains scaling factors further configured from gNB indicating the offset to the largest SSB-RSRP threshold rsrp-LargestThresholdMsg1. The resulting complete set of SSB-RSRP thresholds is: rsrp-ThresholdOffsetList={10, 8, 7, 4} dB.

As an example embodiment, where a multiple number of PRACH repetitions is configured, the corresponding SSB-RSRP threshold values could be derived as rsrp-ThresholdMsg1List (1)=rsrp-LargestThresholdMsg1, rsrp-ThresholdMsg1List (2)=rsrp-ThresholdMsg1List (1)+rsrp-ThresholdOffsetList (1)=10 dB+ (−2) dB=8 dB, rsrp-ThresholdMsg1List (3)=rsrp-ThresholdMsg1List (2)+rsrp-ThresholdOffsetList (2)=8 dB+ (−1) dB=7 dB, rsrp-ThresholdMsg1List (4)=rsrp-ThresholdMsg1List (3)+rsrp-ThresholdOffsetList (3)=7 dB+ (−3) dB=4 dB, where rsrp-ThresholdOffsetList={−2, −1, −3} dB contains scaling factors further configured from gNB indicating the offset of each SSB-RSRP threshold value to the previously derived SSB-RSRP threshold. The resulting complete set of SSB-RSRP thresholds is: rsrp-ThresholdOffsetList={10, 8, 7, 4} dB.

The method may provide harmonization of the PRACH repetitions and Msg3 repetitions parameters, such as the SSB-RSRP thresholds used for triggering the PRACH repetitions and Msg3 repetitions. Methods may allow the derivation of the SSB-RSRP thresholds for PRACH repetitions from the higher layer configured rsrp-ThresholdMsg3-r17.

The method may comprise determining the number of repetitions of the third message of the random access procedure based on the number of repetitions of the first message.

For example, the UE may determine the number of Msg3 PUSCH repetitions from the number of Msg1 PRACH repetitions.

An example method for determining the number of repetitions of the third message of the random access procedure is automatic grant.

In an example embodiment, a UE transmitting PRACH with repetitions assumes that Msg3 repetitions will be granted in response by NW and interprets UL grant carried by Msg2 as per case with no Msg3 repetitions request, i.e., NR Rel-15 to Rel-16 interpretation.

The number of repetitions of the third message of the random access procedure may be proportional to the number of repetitions of the first message of the random access procedure.

In one example embodiment, a UE automatically sets the number of Msg3 PUSCH repetitions proportional to the number of Msg1 PRACH repetition.

In another example embodiment, the field numberOfMsg3-RepetitionsList in BWP-UplinkCommon is not configured and the UE automatically sets the number of Msg3 PUSCH repetitions equal to the number of PRACH repetitions.

The method may comprise receiving an indication of multiple numbers of repetitions of the third message of the random access procedure from the network (e.g., the field numberOfMsg3-RepetitionsList in BWP-UplinkCommon), wherein at least one of the multiple numbers of repetitions of the third message of the random access procedure is associated with at least one of multiple numbers of repetitions of the first message of the random access procedure configured at the user equipment and determining the number of repetitions of the third message of the random access procedure based on the indication.

In one example embodiment, the field numberOfMsg3-RepetitionsList in BWP-UplinkCommon is interpreted by the UE as the number of Msg3 PUSCH repetitions corresponding to one or more certain number of PRACH repetitions.

Multiple number of PRACH repetitions may be configured, and each item of the list numberOfMsg3-RepetitionsList would then be associated to each item of the list for the number of PRACH repetitions.

Multiple number of PRACH repetitions can be configured, and one or more items of the list numberOfMsg3-RepetitionsList would then be associated to one item of the list for the number of PRACH repetitions.

Multiple number of PRACH repetitions may be configured, and each item of the list numberOfMsg3-RepetitionsList would then be associated to one or more items of the list for the number of PRACH repetitions.

The method may comprise receiving a configuration related to the determined at least one threshold, the configuration associating a number of repetitions of the first message of the random access procedure to the at least one determined threshold and either a number of repetitions of the third message of the random access procedure or a proportionality factor to be applied to the associated number of repetitions of the first message to determine the number of repetitions of the third message of the random access procedure to the at least one determined threshold.

In one example embodiment of the configuration described above, a field is introduced associating a number of PRACH repetitions with a number of Msg3 repetitions. In one implementation, each CE level is associated to both a number of PRACH and Msg3 repetitions. In another implementation, each CE level is associated to a number of PRACH repetitions and to a proportionality factor to derive the number of Msg3 repetitions

If the first Msg3 transmission fails and UE receives a Msg3 scheduling command through DCI format 0_0 with CRC scrambled with TC-RNTI, for Msg3 retransmission, the UE interprets it as per Rel-17 interpretation of DCI format 0_0 with CRC scrambled with TC-RNTI for Msg3 repetitions.

An alternative example method involves network grant. The method may comprise receiving an uplink grant or downlink control information from the network and determining whether to perform repetitions of the third message of the random access procedure based on the uplink grant or downlink control information. The uplink grant or downlink control information comprises a modulation and coding scheme and the method may comprise determining whether to perform repetitions of the third message of the random access procedure based on one most significant bit of the modulation and coding scheme.

The method may comprise determining the number of repetitions of the third message of the random access procedure based on at least one of the remaining bits of the modulation and coding scheme.

In an example embodiment, a UE transmitting PRACH with repetitions interprets the UL grant carried by Msg2 (an example of an UL grant), or DCI format 0_0 with CRC scrambled with TC-RNTI (an example of downlink control information), according to an interpretation which assumes that only 1 MSB of the MCS (instead of 2 as per Rel-17) carries information about Msg3 repetitions. More precisely, UE receives indication from gNB on whether it has to perform Msg3 PUSCH repetitions, via the MSB of the MCS field in the RAR UL grant or in the DCI format 0_0; if Msg3 PUSCH repetitions have to be performed, their number (larger than 1) is set according to one of the embodiments below.

The 3 remaining LSBs of the MCS field of the UL grant carried by the UL grant may be as follows.

The second MSB of the field may be reserved, and the two LSBs may be used to indicate MCS for Msg3 as per Rel-17 logic.

The three LSBs may be used to indicate MCS for Msg3, extending Rel-17 logic.

The three LSBs may be reserved. In this example embodiment, UE may set the number of Msg3 repetitions as proportional to the number of Msg1 PRACH repetitions based on the embodiments described for the automatic grant.

The 4 remaining LSBs of the MCS field of the DCI format 0_0 with CRC scrambled with TC-RNTI may be as follows.

The second MSB of the field may be reserved, and the three LSBs may be used to indicate MCS for Msg3 as per Rel-17 logic.

The four LSBs may be used to indicate MCS for Msg3, extending Rel-17 logic.

Alternatively, in case of retransmission of Msg3, the MSB of MCS field in DCI format 0_0 scrambled by TC-RNTI indicates whether the same number of repetitions as the initial transmission is applied or if a higher number of repetitions compared to previous transmission (e.g., the next higher number of repetitions in numberOfMsg3-RepetitionsList-r17) is applied.

The method may provide harmonization of the PRACH repetitions and Msg3 repetitions parameters, such as Msg3 repetitions and the number of repetitions for both channels. For example, the method may allow a UE to implicitly set the number of Msg3 PUSCH repetitions proportional to the number of Msg1 PRACH repetition.

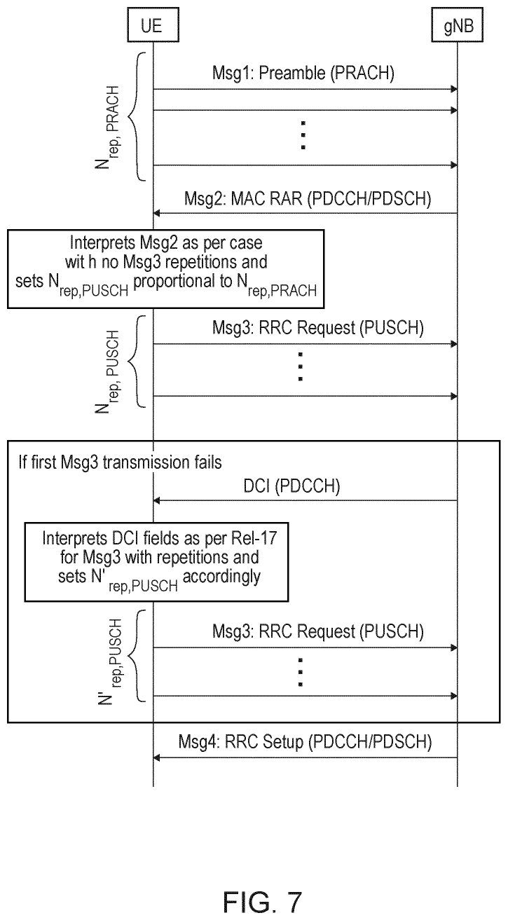

FIG. 7 shows a signalling flow for an example procedure for Msg3 PUSCH repetitions determination for automatic grant.

For automatic grant, the UE sends N_{rep,PRACH} Msg1 (Preamble) repetitions to the gNB, where N_{rep,PRACH} is derived according to a suitable procedure.

The gNB sends Msg2 (MAC RAR) to the UE.

The UE interprets UL grant carried by Msg2 as per case with no Msg3 repetitions request, i.e., NR Rel-15 to Rel-16 interpretation, and sets the number of Msg3 PUSCH repetitions N_{rep,PUSCH} proportional to N_{rep,PRACH}.

The UE sends N_{rep,PUSCH} Msg3 (RRC Request) repetitions to the gNB. If the first Msg3 transmission fails, and the UE receives a DCI format 0_0 with CRC scrambled with TC-RNTI for scheduling Msg3 retransmission, then UE interprets the DCI fields as per Rel-17 interpretation for Msg3 with N′_{rep,PUSCH} repetitions.

Upon reception of Msg3, the gNB sends Msg4 (RRC Setup) to the UE.

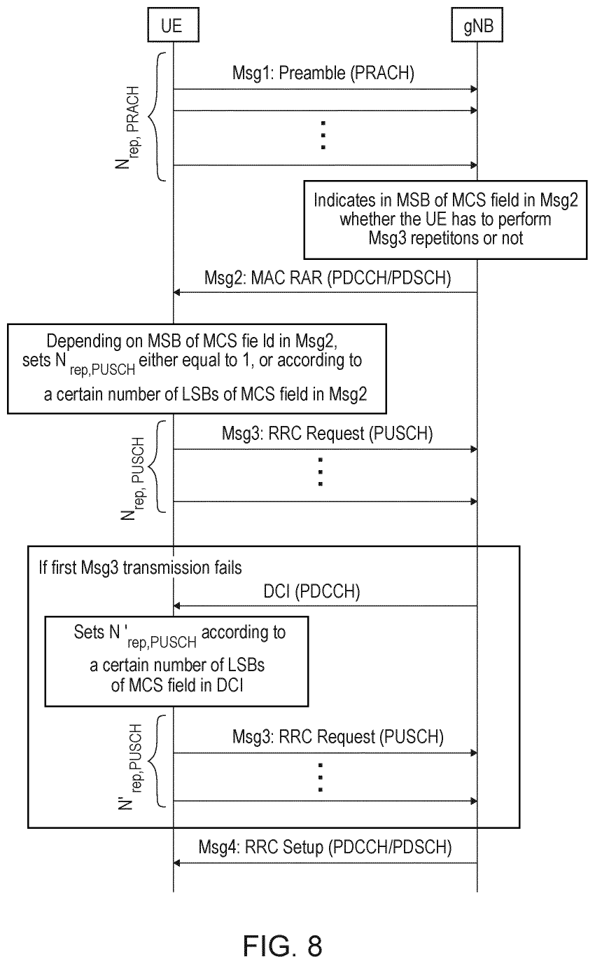

FIG. 8 shows a signalling flow for an example procedure for Msg3 PUSCH repetitions determination for network grant.

The UE sends N_{rep,PRACH} Msg1 (Preamble) repetitions to the gNB, where N_{rep,PRACH} is derived according to some previous procedure among UE and gNB.

The gNB indicate in the MSB of the MCS field in Msg2 whether the UE should perform Msg2 repetitions or not.

The gNB sends Msg2 (MAC RAR) to the UE.

The UE, depending on the MSB of the MCS field in Msg2, sets the number of Msg3 PUSCH repetitions according to one of the following four example embodiments:
N_{rep,PUSCH}=1;
The second MSB of the field is reserved, and the two LSBs are used to indicate MCS for Msg3 repetitions, as per Rel-17 logic;
The three LSBs are used to indicate MCS for Msg3 repetitions, extending Rel-17 logic;
The three LSBs are reserved and the UE sets the number of Msg3 repetitions as proportional to the number of Msg1 PRACH repetitions, e.g., N_{rep,PUSCH}=N_{rep,PRACH}.

The UE sends N_{rep,PUSCH} Msg3 (RRC Request) repetitions to the gNB.

If the first Msg3 transmission fails, and the UE receives a DCI format 0_0 with CRC scrambled with TC-RNTI for scheduling Msg3 retransmission, then UE sets the number of Msg3 PUSCH repetitions (N′_{rep,PUSCH}) according to one of the following two example embodiments:
The second MSB of the field is reserved, and the three LSBs are used to indicate MCS for Msg3 as per Rel-17 logic;
“The four LSBs are used to indicate MCS for Msg3 repetitions, extending Rel-17 logic.

Upon reception of Msg3, the gNB sends Msg4 (RRC Setup) to the UE.

An apparatus may comprise means for receiving, at a user equipment, a threshold for triggering a request for repetitions of a third message of a random access procedure and means for determining at least one threshold for triggering repetitions of a first message of the random access procedure based on the received threshold.

The apparatus may comprise the user equipment, such as a mobile phone, be the user equipment or be comprised in the user equipment or a chipset for performing at least some actions of/for the user equipment.

It should be understood that the apparatuses may comprise or be coupled to other units or modules etc., such as radio parts or radio heads, used in or for transmission and/or reception. Although the apparatuses have been described as one entity, different modules and memory may be implemented in one or more physical or logical entities.

It is noted that whilst some embodiments have been described in relation to 5G networks, similar principles can be applied in relation to other networks and communication systems such as 6G networks or 5G-Advanced networks. Therefore, although certain embodiments were described above by way of example with reference to certain example architectures for wireless networks, technologies and standards, embodiments may be applied to any other suitable forms of communication systems than those illustrated and described herein.

It is also noted herein that while the above describes example embodiments, there are several variations and modifications which may be made to the disclosed solution without departing from the scope of the present invention.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

In general, the various embodiments may be implemented in hardware or special purpose circuitry, software, logic or any combination thereof. Some aspects of the disclosure may be implemented in hardware, while other aspects may be implemented in firmware or software which may be executed by a controller, microprocessor or other computing device, although the disclosure is not limited thereto. While various aspects of the disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
(i) a combination of analog and/or digital hardware circuit(s) with software/firmware and
(ii) any portions of hardware processor(s) with software (including digital signal processor(s)), software, and memory(ies) that work together to cause an apparatus, such as a mobile phone or server, to perform various functions) and

I hardware circuit(s) and or processor(s), such as a microprocessor(s) or a portion of a microprocessor(s), that requires software (e.g., firmware) for operation, but the software may not be present when it is not needed for operation.”

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The embodiments of this disclosure may be implemented by computer software executable by a data processor of the mobile device, such as in the processor entity, or by hardware, or by a combination of software and hardware. Computer software or program, also called program product, including software routines, applets and/or macros, may be stored in any apparatus-readable data storage medium and they comprise program instructions to perform particular tasks. A computer program product may comprise one or more computer-executable components which, when the program is run, are configured to carry out embodiments. The one or more computer-executable components may be at least one software code or portions of it.

Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD. The physical media is a non-transitory media. The term “non-transitory,” as used herein, is a limitation of the medium itself (i.e., tangible, not a signal) as opposed to a limitation on data storage persistency (e.g., RAM vs. ROM).

The memory may be of any type suitable to the local technical environment and may be implemented using any suitable data storage technology, such as semiconductor based memory devices, magnetic memory devices and systems, optical memory devices and systems, fixed memory and removable memory. The data processors may be of any type suitable to the local technical environment, and may comprise one or more of general purpose computers, special purpose computers, microprocessors, digital signal processors (DSPs), application specific integrated circuits (ASIC), FPGA, gate level circuits and processors based on multi core processor architecture, as non-limiting examples.

Embodiments of the disclosure may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The scope of protection sought for various embodiments of the disclosure is set out by the independent claims. The embodiments and features, if any, described in this specification that do not fall under the scope of the independent claims are to be interpreted as examples useful for understanding various embodiments of the disclosure.

The foregoing description has provided by way of non-limiting examples a full and informative description of the exemplary embodiment of this disclosure. However, various modifications and adaptations may become apparent to those skilled in the relevant arts in view of the foregoing description, when read in conjunction with the accompanying drawings and the appended claims. However, all such and similar modifications of the teachings of this disclosure will still fall within the scope of this invention as defined in the appended claims.

Indeed, there is a further embodiment comprising a combination of one or more embodiments with any of the other embodiments previously discussed.

1-13. (canceled)

14. An apparatus comprising at least one processing core and at least one memory storing instructions that, when executed by the at least one processing core, cause the apparatus at least to:
receive, at a user equipment, a threshold for triggering a request for repetitions of a third message of a random access procedure; and
determine at least one threshold for triggering repetitions of a first message of the random access procedure based on the received threshold.

15. The apparatus according to claim 14, wherein the at least one processing core and at the least one memory storing instructions that, when executed by the at least one processing core, further cause the apparatus at least to:
receive at least one delta value from the network at the user equipment; and
determine the at least one threshold for triggering the repetitions of the first message of the random access procedure further based on the at least one delta value.

16. The apparatus according to claim 15, wherein the at least one delta value comprises a set of delta values and the at least one threshold comprises a set of thresholds, each delta value of the set of delta values used by the apparatus to determine each threshold of the set of thresholds, each threshold of the set of thresholds corresponding to a number of repetitions of the first message of the random access procedure configured at the user equipment.

17. The apparatus according to claim 14, wherein the received threshold and the at least one determined threshold comprise a reference signal received power threshold of a synchronisation signal block.

18. The apparatus according to claim 14, wherein the at least one processing core and at the least one memory storing instructions that, when executed by the at least one processing core, further cause the apparatus at least to:
determine a number of repetitions of the third message of the random access procedure based on a number of repetitions of the first message of the random access procedure.

19. The apparatus according to claim 18, wherein the number of repetitions of the third message of the random access procedure is proportional to the number of repetitions of the first message.

20. The apparatus according to claim 18, wherein the at least one processing core and at the least one memory storing instructions that, when executed by the at least one processing core, further cause the apparatus at least to:
receive an indication of multiple numbers of repetitions of the third message of the random access procedure from the network, wherein at least one of the multiple numbers of repetitions of the third message of the random access procedure is associated with at least one of multiple numbers of repetitions of the first message of the random access procedure configured at the user equipment; and
determine the number of repetitions of the third message of the random access procedure based on the indication.

21. The apparatus according to claim 18, wherein the at least one processing core and at the least one memory storing instructions that, when executed by the at least one processing core, further cause the apparatus at least to:
receive a configuration related to the determined at least one threshold, the configuration associating a number of repetitions of the first message of the random access procedure to the at least one determined threshold and either a number of repetitions of the third message of the random access procedure or a proportionality factor to be applied to the associated number of repetitions of the first message to determine the number of repetitions of the third message of the random access procedure to the at least one determined threshold.

22. The apparatus according to claim 14, wherein the at least one processing core and at the least one memory storing instructions that, when executed by the at least one processing core, further cause the apparatus at least to:
receive an uplink grant or downlink control information from the network; and
determine whether to perform repetitions of the third message of the random access procedure based on the uplink grant or downlink control information.

23. The apparatus according to claim 22, wherein the uplink grant or downlink control information comprises a modulation and coding scheme and wherein the at least one processing core and at the least one memory storing instructions that, when executed by the at least one processing core, further cause the apparatus at least to:
determine whether to perform repetitions of the third message of the random access procedure based on one most significant bit of the modulation and coding scheme.

24. The apparatus according to claim 23, wherein the at least one processing core and at the least one memory storing instructions that, when executed by the at least one processing core, further cause the apparatus at least to:
determine the number of repetitions of the third message of the random access procedure based on at least one of the remaining bits of the modulation and coding scheme.

25. A method comprising:
receiving, at a user equipment, a threshold for triggering a request for repetitions of a third message of a random access procedure; and
determining at least one threshold for triggering repetitions of a first message of the random access procedure based on the received threshold.

26. The method according to claim 25, further comprising:
receiving at least one delta value from the network at the user equipment; and
determining the at least one threshold for triggering the repetitions of the first message of the random access procedure further based on the at least one delta value.

27. The method according to claim 26, wherein the at least one delta value may comprise a set of delta values and the at least one threshold may comprise a set of thresholds, each delta value of the set of delta values used by the apparatus to determine each threshold of the set of thresholds, each threshold of the set of thresholds corresponding to a number of repetitions of the first message of the random access procedure configured at the user equipment.

28. The method according to claim 25, wherein the received threshold and the at least one determined threshold comprise a reference signal received power threshold of a synchronisation signal block.

29. The method according to claim 25, further comprising:
determining a number of repetitions of the third message of the random access procedure based on a number of repetitions of the first message of the random access procedure.

30. The method according to claim 29, wherein the number of repetitions of the third message of the random access procedure is proportional to the number of repetitions of the first message.

31. The method according to claim 29, further comprising:
receiving an indication of multiple numbers of repetitions of the third message of the random access procedure from the network, wherein at least one of the multiple numbers of repetitions of the third message of the random access procedure is associated with at least one of multiple numbers of repetitions of the first message of the random access procedure configured at the user equipment; and
determining the number of repetitions of the third message of the random access procedure based on the indication.

32. The method according to claim 29, further comprising:
receiving a configuration related to the determined at least one threshold, the configuration associating a number of repetitions of the first message of the random access procedure to the at least one determined threshold and either a number of repetitions of the third message of the random access procedure or a proportionality factor to be applied to the associated number of repetitions of the first message to determine the number of repetitions of the third message of the random access procedure to the at least one determined threshold.

33. A computer readable medium comprising instructions which, when executed by an apparatus, cause the apparatus to perform at least the following:
receiving, at a user equipment, a threshold for triggering a request for repetitions of a third message of a random access procedure; and
determining at least one threshold for triggering repetitions of a first message of the random access procedure based on the received threshold.
